(19) United States
(12) Patent Application Publication
(10) Pub. No.: US 2009/0274313 A1
(43) Pub. Date: Nov. 5, 2009

(54) Slotted Waveguide Acoustic Output Device and Method

(76) Inventors: W. Richard Klein, Houston, TX (US); Domingo Castro, JR., Houston, TX (US); David C. Tigwell, Houston, TX (US)

Correspondence Address: John Karl Buche;BUCHE & ASSOCIATES, P.C., 875 PROSPECT, SUITE 305, LA JOLLA, CA, 92037, US

(21) Appl. No.: 12/114,908

(22) Filed: May 5, 2008

(51) Int. Cl. H04R 29/00; H04R 1/20

(52) U.S. Cl. 381/59; 381/338

(57) ABSTRACT

The present application is directed to an omnidirectional sound emitting device comprising an acoustic slotted waveguide array; and an acoustic source in communication with the acoustic slotted waveguide array. The device is configured to project an acoustic beam at distance up to about two nautical miles or more.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE APPLICATION

The application relates generally to an acoustic configuration for providing auditory signaling.

### BACKGROUND

Sound generating devices are commonly employed at sea to broadcast audible signals and communicate to marine vessel operators as to the approximate locations of nearby obstructions to marine traffic, i.e., offshore drilling platforms, artificial islands, dry land, etc. Because marine vessels may approach obstructions from any direction, it is common to broadcast an audible signal 360° over the horizon plane for a predetermined distance in order to supply ample warning to vessel operators as to the location of the nearby obstruction. Although standards vary as to a warning signal's range, in marine environments, typical sound emitters are required to broadcast audible signals to a distance of about one-half nautical mile to about two nautical miles.

Typical sound generating devices used to broadcast audible signals include, for example, electronically powered multi-emitter arrays having several emitters, i.e., acoustic drivers, in vertical alignment within an external framework. The vertical alignment of the acoustic drivers broadcasts a beam of sound onto the horizon plane. For example, five or more acoustic drivers may be used to project a sound signal two nautical miles or more. An exemplary multi-emitter array is shown in FIG. 1.

The stronger the desired signal or the more energy efficient the acoustic generator, the more acoustic drivers that may be needed in the array. Increasing the number of acoustic drivers results in increased costs related to (1) the cost of each additional emitter, (2) the material costs related to the external framework necessary to support additional acoustic drivers in the array, and (3) cabling associated with the multiplicity of drivers.

Accordingly, there is a need for a less expensive sound generating device to broadcast a beam of sound 360° onto the horizon plane to an audible distance comparable to that of known sound generating devices by employing fewer acoustic drivers than known sound generating devices.

### SUMMARY

The present application is directed to an omnidirectional sound emitting device comprising an acoustic slotted waveguide array; and an acoustic source in communication with the acoustic slotted waveguide array, the acoustic source configured to generate an acoustic frequency; wherein the device is configured to project an acoustic beam at distance up to about two nautical miles or more.

The present application is also directed to an omnidirectional sound emitting device comprising a uniform cross section acoustic waveguide having a first open end and a second closed end; an acoustic source attached to the first open end of the waveguide, said acoustic source in communication with the waveguide; a plurality of in-phase radiating apertures in the wall of the waveguide equidistant from one another.

The present application is also directed to an omnidirectional sound emitting device for projecting an acoustic beam onto a horizon plane comprising a uniform cross section acoustic waveguide; an acoustic source in communication with the waveguide at a first end of the waveguide, wherein the acoustic source is configured to generate acoustic energy including acoustic energy propagated in a first direction along the longitudinal axis of the waveguide; a plurality of in-phase sets of apertures in the wall of the waveguide, the sets of apertures being equidistant from one another; and a reflector surface located at a second end of the waveguide a distance from its nearest set of apertures effective to redirect the acoustic energy generated by the acoustic source in a second opposite direction through the waveguide effective to produce pressure amplitude maxima at the sets of apertures.

The present application is also directed to a method of projecting a constant acoustic beam onto a horizon plane, said method comprising providing an omnidirectional sound emitting device including, a uniform cross section cylindrical acoustic waveguide having a first open top end and a second closed bottom end; an acoustic source attached to the first open end of the waveguide, said acoustic source in communication with the waveguide; a reflector surface defining the second closed end of the waveguide; and a plurality of in-phase radiating apertures in the wall of the waveguide equidistant from one another and rotated about the waveguide axis to avoid excessive shadowing in any direction on the horizon plane; directing the acoustic source to generate an acoustic field of a single frequency propagated in a first direction within the acoustic waveguide, the frequency having a wavelength substantially equal to the distance between adjacent radiating sources; producing substantially similar sound pressure levels at the in phase radiating apertures to project an acoustic beam onto the horizon plane through the in phase radiating apertures; measuring the sound pressure levels at the radiating sources; and adjusting the frequency generated by the acoustic source to maintain similar sound pressure levels at each of the radiating in phase apertures in response to sound pressure level measurements.

The present application is also directed to a method of maintaining the optimum efficiency of an acoustic slotted waveguide array as the acoustic velocity within the waveguide changes over time and temperature, the method comprising the following steps: providing an acoustic slotted waveguide array comprising an acoustic source in communication with the waveguide at a first end, said acoustic source configured to generate an acoustic field; a reflector surface defining the second closed end of the waveguide; and a plurality of in-phase apertures in the wall of the waveguide, wherein the distance between in phase apertures is known; wherein the distance between the acoustic source and the nearest in phase aperture thereto is known; and wherein the distance between the reflector surface and the nearest in phase aperture thereto is known; establishing an acoustic frequency effective to produce about equal sound pressure levels at all apertures; comparing changes in the sound pressure levels at the apertures; adjusting the acoustic frequency generated by the acoustic source as to maintain about equal sound pressure levels at all apertures during operation of the waveguide array.

### BRIEF DESCRIPTION OF THE FIGURES

So that the manner in which the features and advantages of the invention, as well as others will become apparent and may be understood in more detail, a more particular description of the invention briefly summarized above may be had by reference to the embodiments thereof which are illustrated in the appended drawings, which form a part of this specification. It is to be noted, however, that the drawings illustrate only various embodiments of the invention and are therefore not to be considered limiting of the invention's scope as it may include other effective embodiments as well.

FIG. 1 illustrates a side view of a known multi-emitter phased array.

FIG. 2 illustrates a side view of an exemplary omnidirectional sound emitting device.

FIG. 3 illustrates a side view of an acoustic waveguide with periodically spaced apertures.

FIG. 4 illustrates a top cross-sectional view through the acoustic waveguide of aperture set B.

FIG. 5 illustrates a side view of an acoustic waveguide having five sets of apertures.

FIG. 6 illustrates a top cross-sectional view of each of the five sets of apertures of FIG. 5 rotated in the transverse plane through equal angles.

FIG. 7 illustrates a side view of an omnidirectional sound emitting device including an illustration of an acoustic waveform propagated within an acoustic waveguide and the acoustic energy as emitted from the waveguide. Note: the wavelength inside the waveguide is not equal to the wavelength outside in the acoustic radiation field.

FIG. 8 illustrates a side view of the acoustic waveguide described in Example 1.

FIG. 9 illustrates measured sound pressure levels within respective sets of apertures versus acoustic frequency for a distance of 2.75 inches between the face of the acoustic driver and the nearest aperture set.

FIG. 10 illustrates the ratio of average aperture sound pressure levels to input electrical power to the acoustic driver under the conditions of FIG. 9.

FIG. 11 illustrates a plot of (a) frequency of peak efficiency and (b) frequency of optimum uniformity of sound pressure among apertures versus distance between the face of the acoustic driver and the nearest aperture set.

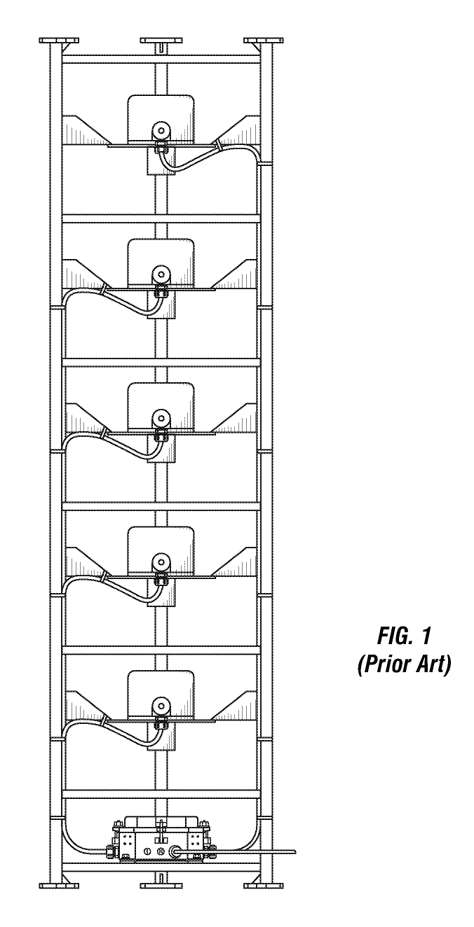

### BRIEF DESCRIPTION

It has been found that an omnidirectional sound emitting device comprising a uniform cross section acoustic waveguide and a single acoustic driver can be configured to project an acoustic beam onto a plane at least a distance about equal to that of known sound generating devices. In particular, it has been found that an omnidirectional sound emitting device comprising a uniform cross section acoustic waveguide having a plurality of apertures equally spaced (center to center) along the waveguide surface can be configured to project an omnidirectional acoustic beam in the region surrounding the device on a plane substantially perpendicular to the longitudinal axis of the waveguide. It has also been found that an omnidirectional sound emitting device comprising a single acoustic driver attached to a uniform cross section acoustic waveguide having a plurality of in-phase radiating sources of acoustic energy may be monitored and adjusted to maintain optimum efficiency of the device during operation. Such a desirable achievement has neither been made, nor previously considered possible; accordingly, the omnidirectional sound emitting device and method of this application measure up to the dignity of patentability and represent a patentable concept.

Before describing the invention in detail, it is to be understood that the present device and method are not limited to particular embodiments. It is also to be understood that the terminology used herein is for the purpose of describing particular embodiments only, and is not intended to be limiting. As used in this specification and the appended claims, the phrases “acoustic source,” “sound emitter,” and “acoustic driver” can be used interchangeably to mean a source of an acoustic field including at least one frequency. The terms “generate,” “transmit,” “broadcast,” “project,” and variations thereof may be used interchangeably meaning to create a propagating acoustic field in a region around the device wherein the device is the originating source of any acoustic energy. The phrase “horizon plane” refers to a substantially horizontal plane or a plane transverse or substantially perpendicular to the longitudinal axis of a vertically aligned waveguide (those of ordinary skill in the art will appreciate that these terms do not necessarily define an exact trajectory, direction, or shapes of wave energy). The acronym “IALA” refers to the International Association of Marine Aids to Navigation and Lighthouse Authorities. The term “shadowing” herein means a region of reduced acoustic pressure caused by the presence of an object within an acoustic field. The term “dimension” as applied to the apertures and solid connectors of this application refers to the (a) height of the apertures and solid connectors and (b) the angle of the apertures and solid connectors relative to the central axis of the waveguide. The term “transducer” refers to a device that converts electrical energy into acoustic energy.

In one aspect, the present application provides an acoustic slotted waveguide array configured to project an acoustic beam onto the horizon plane.

In another aspect, the present application provides a sound emitting device comprising an acoustic source in communication with an acoustic slotted waveguide array, the device being configured to project an acoustic beam onto a plane substantially perpendicular to the longitudinal axis of the acoustic slotted waveguide array at a distance of about two nautical miles or more.

In another aspect, the present application provides a device comprising an acoustic source in communication with an acoustic slotted waveguide array configured to project an acoustic beam onto a horizon plane.

In another aspect, the present application provides an acoustic slotted waveguide array including apertures alternated in the transverse plane and configured to act as in-phase acoustic sources for transmitting sound in a 360 degree pattern in the transverse plane, substantially perpendicular to the longitudinal axis of the waveguide.

In another aspect, the present application provides a sound emitting device capable of projecting an acoustic beam onto the horizon plane to a distance equal to or greater than known in-phase multi-emitter arrays, i.e., a distance of about two (2) nautical miles or more.

In another aspect, the present application provides a sound emitting device comprising a single acoustic driver configured to project an acoustic beam onto a horizon plane to a distance about equal to known in-phase multi-emitter arrays, i.e., a distance of about two (2) nautical miles.

In another aspect, the present application provides a sound emitting device comprising a single acoustic driver that meets the requirements for a nominal range from one-half to two nautical miles according to 33 C.F.R. Ch. I (7-1-06 Edition) Paragraph 67.10-25 (United States Coast Guard, DHS) as of the date of this application.

In another aspect, the present application provides a sound emitting device comprising a single acoustic driver that meets the two nautical mile range rating of the IALA as of the date of this application.

In another aspect, the present application provides an omnidirectional sound emitting device comprising an acoustic slotted waveguide array including about equally spaced apertures along the waveguide surface wherein the acoustic frequency generated by the device may be monitored and adjusted to produce a wavelength within the waveguide equal to the center to center aperture spacing.

In another aspect, the present application provides an omnidirectional sound emitting device comprising (1) an acoustic slotted waveguide array configured to confine a wave to an essentially single dimension, the waveguide having about equally spaced sets of apertures along the waveguide, and (2) an acoustic driver source attached to a first end of the waveguide configured to generate a waveform within the waveguide of a predetermined wavelength, wherein the distance from a second end of the waveguide to the center of the aperture set nearest the second end is equal to about one-half wavelength.

In another aspect, the present application provides an omnidirectional sound emitting device comprising (1) an acoustic slotted waveguide array configured to confine a wave to an essentially single dimension, the waveguide having about equally spaced sets of apertures along the waveguide, (2) an acoustic driver source attached to a first end of the waveguide configured to generate a waveform within the waveguide of a predetermined wavelength, and (3) a closed second end of the waveguide wherein the distance from the second end of the waveguide to the center of the aperture set nearest the second end is equal to about one-half wavelength, whereby optimum sound pressure levels at each aperture set and optimum transduction efficiency of electrical energy to acoustic energy of the device may be accomplished by adjusting the distance between the acoustic driver source and the aperture set nearest the acoustic source.

In another aspect, the present application provides an omnidirectional sound emitting device comprising an acoustic slotted waveguide array having about equally spaced apertures along the waveguide whereby the device may produce uniform sound pressure levels at each of the apertures.

In another aspect, the present application provides an omnidirectional sound emitting device including a slotted waveguide in communication with an acoustic source, wherein the dominant frequency of the device is inversely proportional to the internal length of the waveguide.

In another aspect, the present application provides an omnidirectional sound emitting device including a slotted waveguide in communication with an acoustic source to be located in a marine environment and controlled remotely.

In another aspect, the present application provides an omnidirectional sound emitting device comprising (1) an acoustic slotted waveguide array including a first open end and a second closed end and having about equally spaced apertures along the waveguide, and (2) an acoustic source, whereby optimum sound pressure levels at each of the apertures and optimum transduction efficiency of electrical energy to acoustic energy of the device may occur at the same frequency by adjusting the distance between the acoustic source at the first end of the waveguide and the aperture nearest the acoustic source, and/or adjusting the distance between the closed second end of the waveguide and the aperture nearest the second end, and/or adjusting the dimensions of the individual apertures, and/or adjusting the acoustic frequency generated by the acoustic source.

In another aspect, the present application provides an omnidirectional sound emitting device comprising a center fed waveguide including (1) two opposing acoustic sources facing one another at a point along the length of the waveguide, and (2) two closed ends of the waveguide.

In another aspect, the present application provides a slotted waveguide acoustic output device comprising an acoustic source and one or more microphones located within the waveguide wall configured to convert characteristic acoustic parameters within the waveguide into an electrical signal used to monitor and control acoustic frequency generated by the acoustic source.

In another aspect, the present application provides a slotted waveguide acoustic output device comprising an acoustic source, one or more microphones located within the waveguide wall, a frequency controlled oscillator, and a microprocessor based frequency generator configured to (1) monitor the output of the one or more microphones and/or the input impedance characteristics of the acoustic source, and (2) act on the frequency controlled oscillator to modify the frequency generated by the acoustic source to maintain pressure amplitude maxima at the apertures based on the output of the one or more microphones.

In another aspect, the present application provides a slotted waveguide acoustic output device wherein the measuring of sound pressure level is accomplished via placing one or more microphones within the waveguide wall, wherein the one or more microphones are configured to convert the acoustic pressure within the waveguide into an electrical signal of characteristic frequency.

In another aspect, the present application provides a slotted waveguide acoustic output device wherein adjusting of frequency is accomplished via communicating sound pressure characteristics measured by one or more microphones to an audio frequency generator whereby the audio frequency generator acts on the fed back electrical signals to modify the frequency generated by the acoustic source of the device in order to maintain pressure amplitude maxima at the radiating sources of the waveguide based on the output of the one or more microphones.

In another aspect, the present application provides a slotted waveguide acoustic output device wherein the device projects a substantially constant acoustic beam onto a horizon plane to a distance from about one-half nautical mile to about two nautical miles.

The various characteristics described above, as well as other features, objects, and advantages will be apparent from the following detailed description and accompanying drawings, wherein like reference numerals are used for like features throughout the several views. It is to be fully recognized that the different teachings of the embodiments disclosed herein may be employed separately or in any suitable combination to produce desired results.

### DETAILED DESCRIPTION

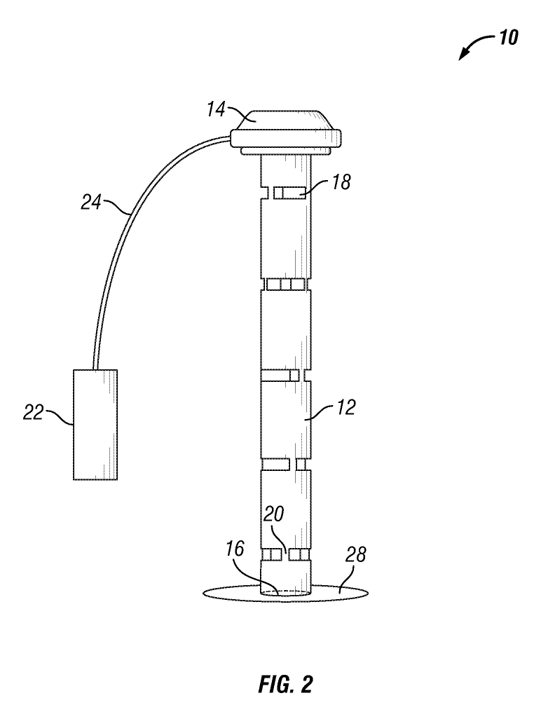

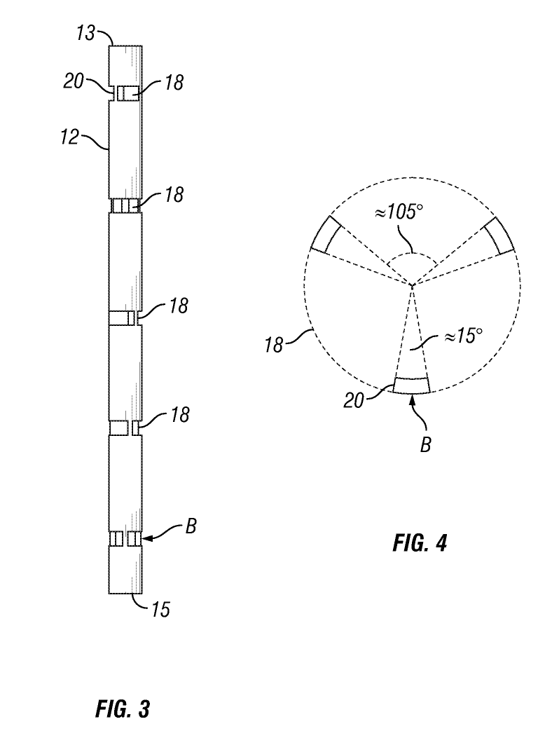

Referring to FIG. 2, a sound generating device 10 (hereafter “device”) is provided comprising at least an acoustic waveguide 12 having an inner surface and an outer surface, and an acoustic source 14 in communication with the acoustic waveguide 12, the acoustic source 14 being configured to generate an acoustic field that is ultimately projected out from the waveguide 12 onto a transverse plane substantially perpendicular to the longitudinal axis of the waveguide 12. The waveguide 12 suitably comprises a first open end 13 a second closed end 15 (see FIG. 3) defined by a reflector surface 16, and a plurality of apertures 18 in the wall of the waveguide 12. Suitably, the acoustic source 14 is configured to releasably attach to the first open end of the waveguide 12 thereby effectively sealing each end of the waveguide 12 during operation of the device 10. As will be discussed in more detail below, the optimum frequency generated by the acoustic source 14 may be determined, maintained and/or adjusted in order to (1) provide uniform sound pressure levels at each aperture 18, and (2) maximize the overall transduction efficiency of electrical energy to acoustic energy during operation of the device 10.

A simplified illustration of the waveguide 12 is shown in FIG. 3. In one embodiment, the waveguide 12 may be of circular cross-section. In another embodiment, the waveguide 12 may comprise at least a multi-sided tubular inner surface and a multi-sided outer surface. In a particularly advantageous embodiment, the inner surface of the waveguide 12 comprises a uniform cross section configured to confine a stationary wave to an essentially single dimension during propagation along the longitudinal axis of the waveguide 12.

As illustrated by FIG. 3, the waveguide 12 suitably includes an array of apertures 18 spaced along the waveguide 12 wall, each aperture set 18 being configured to allow acoustic energy to escape or otherwise leak out from the waveguide 12 through one or more aperture sets 18. In another embodiment, apertures 18 may be arranged in sets or groups of apertures 18, whereby each set of apertures 18 is located a different distance from the first end 13 of the waveguide 12, so that individual apertures 18 in a particular aperture set may be equidistant from the first end 13. Likewise, each aperture set is located a different distance from the second closed end 15 of the waveguide 12, so that individual apertures 18 in a particular aperture set are equidistant from the second closed end 15. Although apertures 18 may be arranged along the waveguide 12 as desired, in a particularly advantageous embodiment the aperture sets are spaced at about equal intervals along the waveguide 12.

Although not necessarily limited to any particular number of apertures 18, each aperture set suitably includes one or more apertures 18. Suitably, the one or more apertures 18 are defined by equiangular transverse planar slots through the waveguide 12 wall, each aperture 18 or slot configured to act as an in-phase radiating source of the acoustic energy that is generated by the acoustic source 14 and propagated along the longitudinal axis of the waveguide 12. Although not necessarily limited to a particular array, the apertures 18 of the device 10 suitably comprise substantially similar dimensions effective to produce uniform sound pressure levels at each aperture 18.

In one embodiment, as illustrated in the Figures, the apertures 18 may be machined or otherwise formed in the waveguide 12 wall to specific dimensions thereby forming openings therethrough. It is also contemplated that adjustable collars may be incorporated either permanently or at least during initial testing of a particular device 10 in order to establish (1) the aperture 18 dimensions and/or (2) the distance of the apertures 18 along the waveguide 12 relative to the first and second ends 13, 15.

The waveguide 12 further includes one or more solid connectors 20 in the transverse plane of the apertures 18—the solid connectors 20 configured to maintain the structural integrity of the waveguide 12 at each aperture set location. As shown in FIG. 4, each aperture set typically comprises a 1:1 ratio of apertures 18 to solid connectors 20. In similar fashion to the apertures 18, each of the solid connectors 20 comprise substantially similar dimensions. It will be recognized by one of ordinary skill that the height of the apertures 18 and solid connectors 20 are substantially similar in any one aperture set. It is also contemplated herein that any one aperture set may include apertures 18 and/or solid connectors 20 comprising dimensions different from those of other aperture sets. In a particularly advantageous embodiment of a waveguide 12, the apertures 18 comprise uniform dimensions and shapes. For example, in the simplified embodiment of FIG. 3, the waveguide 12 comprises five aperture sets, each set comprising three equiangular apertures 18 and three equiangular solid connectors 20—each aperture 18 of the device 10 comprising an inner perimeter having four sides and a uniform height; each solid connector 20 of the device 10 also comprising a uniform height.

As previously stated, the solid connectors 20 are configured to maintain the structural integrity of the waveguide 12. Thus, the height and angle of the solid connectors 20 may vary based on any number of factors including, but not necessarily limited to the intended use of the device 10, the materials of construction of the waveguide 12, the thickness of the waveguide 12 wall, the inner diameter of the waveguide 12, the outer diameter of the waveguide 12, whether the wall of the waveguide 12 is circular or multi-sided, the length of the waveguide 12, and combinations thereof. In an embodiment including a cylindrical waveguide 12, each of the solid connectors 20 suitably comprises an angle relative to the waveguide 12 longitudinal axis ranging from about 13° to about 17°—including corresponding apertures 18 comprising an angle relative to the waveguide 12 longitudinal axis ranging from about 103° to about 107°. In a particularly advantageous embodiment, the waveguide 12 comprises (1) equiangular solid connectors 20, each comprising an angle relative to the waveguide 12 axis of 15°; and (2) corresponding apertures 18, each comprising an angle relative to the waveguide 12 axis of 105°—as shown in the simplified illustration of FIG. 4.

The apertures 18 may be arranged along the waveguide 12 in a manner effective for the emittance of sound out from the waveguide 12 as desired. In one embodiment, successive sets of apertures may comprise apertures 18 having the same angular orientation. In another embodiment, successive sets of apertures may comprise apertures 18 rotated in the transverse plane through differing angles whereby no two aperture sets comprise apertures 18 having the same angular orientation with reference about the longitudinal axis of the acoustic waveguide. In a particularly advantageous embodiment, successive aperture sets comprise apertures 18 rotated in the transverse plane through equal angles whereby no two aperture sets comprise apertures 18 having the same angular orientation—thereby avoiding excessive shadowing in any direction on the transverse plane.

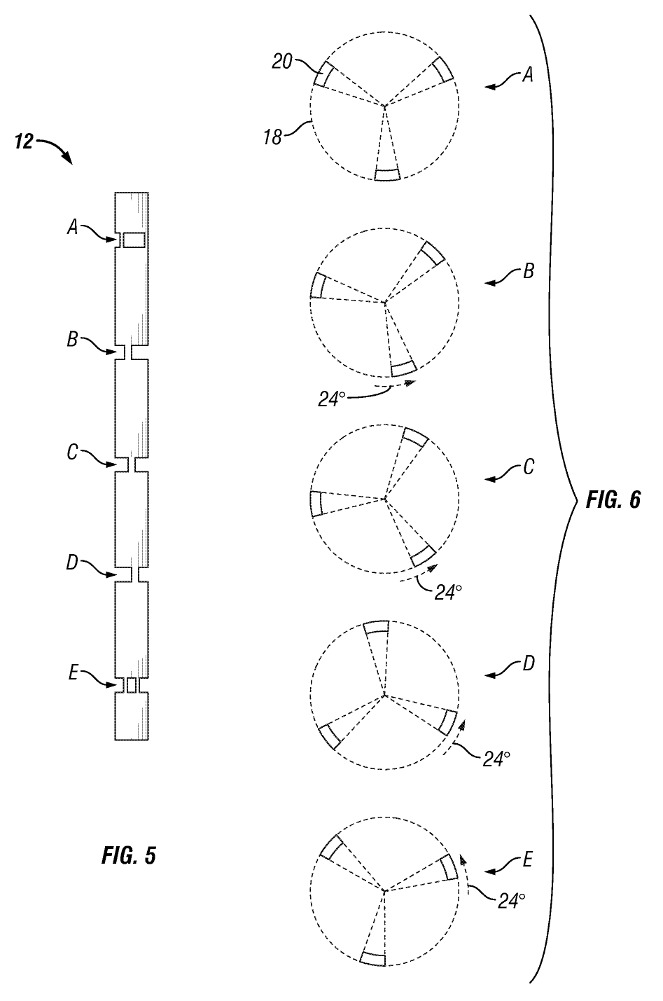

In general, the apertures 18 are rotated about the longitudinal axis of the waveguide 12 in a manner effective to project sound in all directions out from the waveguide 12 on a plane substantially perpendicular to the longitudinal axis of the waveguide 12. In other words, the rotation of the apertures 18 in the transverse plane is effective for the propagation of an acoustic field in a region 360° out from the waveguide 12 perpendicular to the longitudinal axis of the waveguide 12—thereby avoiding excessive shadowing in any direction on the transverse plane. For example, in a marine environment, this configuration assures maximum uniformity of the acoustic field on the horizon plane. The ultimate angle of rotation of apertures 18 is not necessarily limited. However, a favored angle of rotation of the apertures 18 about the waveguide 12 axis may depend on various factors including, but not necessarily limited to the length of the waveguide 12, the total number of aperture sets along the waveguide 12, and combinations thereof. Suitably, the angle of rotation of the apertures 18 about the waveguide 12 axis are such that the angle of rotation between the first and last aperture sets is the same as the angle of rotation between any two adjacent aperture sets along the waveguide 12. In a particularly advantageous embodiment, as shown in FIGS. 5 and 6, sets having three apertures 18 each are rotated about the waveguide 12 axis 24° in the transverse plane—although angles of rotation greater and less than 24° are also herein contemplated.

Although not necessarily limited to a particular material, the waveguide 12 and the reflector surface 16 are suitably constructed of one or more materials effective to maintain a plane wavefront of constant cross-section as the wave propagates in a first direction from the first end 13 of the waveguide 12 to the second end 15 of the waveguide 12 and vice versa. In particular, the reflector surface 16 is suitably constructed from one or more materials effective to reflect the wave generated by the acoustic source 14 to propagate in a second opposite direction through the waveguide 12. Suitable waveguide 12 and reflector surface 16 materials include, but are not necessarily limited to metals including ferrous metals and non-ferrous metals, plastics, composite materials, and combinations thereof. In a particularly advantageous embodiment, the waveguide 12 and reflector surface 16 are each constructed from aluminum.

In one embodiment, the waveguide 12 may be machined from extruded tubing. In another embodiment, the waveguide 12 and reflector surface 16 may comprise separate components that are sealably attached at the second end 15 of the waveguide 12. For example, the waveguide 12 may be constructed from aluminum pipe or tubing including, but not necessarily limited to schedule 40, schedule 80 and schedule 120 aluminum pipe or tubing. Likewise, the reflector surface 16 may be constructed from a flat plate type material.

Although the device 10 may be built to scale, a suitable waveguide 12 configured for marine applications and effective to project an acoustic beam onto a horizon plane at distance of about two nautical miles or more comprises a schedule 80 aluminum pipe having the following dimensions:
Length: (about 178 cm to about 200 cm) (about 70.0 inches to about 77.0 inches)
Outer Diameter: (about 8.90 cm to about 16.8 cm) (about 3.50 inches to about 6.60 inches)
Inner Diameter: (about 7.60 cm to about 15.4 cm) (about 3.00 inches to about 6.10 inches).

Although the device 10 may be used for various applications, a suitable acoustic source 14 is effective to provide auditory information in marine environments. In a suitable embodiment, the acoustic source 14 is configured to generate a continuous, quasi-continuous or a periodic sounding acoustic field of a single frequency within the waveguide 12. Although not necessarily limited to a particular range, in order for the device 10 to project an acoustic beam onto a horizon plane at distance of about two nautical miles or more, the acoustic source 14 suitably produces an acoustic frequency from about 400 Hertz to about 1000 Hertz. Examples of suitable acoustic sources 14 include, but are not necessarily limited to low frequency driver units, midrange driver units, and high frequency driver units commonly used in audio speakers, acoustic horns and the like.

As desired, the acoustic source 14 may be permanently or releasably attached to the first open end 13 of the waveguide 12. In one embodiment, the acoustic source 14 may attach to the waveguide 12 via a slip-on fit including slipping over the outer surface of the first open end 13 of the waveguide 12. In another embodiment, the acoustic source 14 may attach to the waveguide 12 via a slip-on fit including slipping part of the acoustic source 14 within the inner surface of the first open end 13 of the waveguide 12. In still another embodiment, a joint or other coupling means may be used to attach the acoustic source 14 to the first open end 13 of the waveguide 12. In yet another embodiment, a joint or other coupling means may be used to attach two or more acoustic sources 14 to the first end of the waveguide 12. Although attachment of the acoustic source 14 to the first open end 13 of the waveguide 12 is not necessarily limited to any particular fastening means, suitable fastening means include, but are not necessarily limited to bolts, removable pins, spring loaded pins, a threaded connection, clamps, and combinations thereof. A suitable acoustic source 14 may be obtained commercially from JBL, located in Northridge, Calif.

As illustrated in FIG. 2, the device 10 may employ a separate power source 22 either attached directly to the acoustic source 14 or via a link 24. In one embodiment, electrical input to the acoustic source 14 may be provided by a power source 22 including a frequency controlled oscillator configured to produce temporal sound characters including, for example, alternating on/off signals and Morse letters.

Depending on the ultimate use of the device 10, the acoustic source 14 may be further modified as desired to withstand various harsh environmental conditions, i.e., marine environments. For instance, the acoustic source 14 may comprise a waterproof outer housing (not shown) configured to releasably attach to the first open end of the waveguide 12 and envelop the acoustic source 14 therein—thereby sealing the first open end 13 of the waveguide 12 during operation of the device 10. In one embodiment, the waterproof outer housing may comprise an inner dimension, i.e., size and shape, effective to accommodate various acoustic sources 14. In another embodiment, the waterproof outer housing may be configured to accommodate a particular acoustic source 14 having a specific outer shape and dimension. Suitably, the waterproof outer housing comprises a split body design including a compressed gasket therebetween, effective for sealing against ingress of moisture. In addition, the waterproof outer housing suitably comprises an opening therethrough configured to mate with the waveguide 12 at the first open end 13. In a particularly advantageous embodiment including a vertically erect waveguide 12, the opening of the waterproof outer housing is oriented in a downward direction and configured to permit exit of acoustic energy from the acoustic source 14 and to release any accumulated moisture by gravity from the outer housing into the waveguide 12 via open end 13.

The waterproof outer housing may be constructed from materials including, but not necessarily limited to those materials resistant to chipping, cracking, excessive bending and reshaping as a result of ozone, weathering, heat, moisture, and other outside mechanical and chemical influences. In particular, the waterproof outer housing may be constructed from ferrous metals, non-ferrous metals, plastics, composite materials, and combinations thereof. A suitable non-ferrous metal includes aluminum. In a particularly advantageous embodiment, the outer housing is constructed from a composite material of compression molded fiberglass with polyester resin. In addition, the waterproof outer housing may further include a corrosion resistant outer coating. A suitable outer coating includes for example, polyurethane paint.

Once assembled, the device 10 may be mounted to either a stationary or non-stationary structure. In marine environments, the device 10 is suitably mounted to structures effective to maintain the device 10 above sea level during operation of the device 10. Suitable structures include, but are not necessarily limited to offshore platforms, buoys, floating production systems, ships, natural structures such as islands and sand bars, pilings and piers. Depending on the desired orientation of the device 10 during operation, different mounting means may be incorporated to secure one or more parts of the device 10 to a structure. For example, in an embodiment where the waveguide 12 is set in a vertical alignment, the device 10 may be secured to a floor or other base surface via one or more fastening means. In another embodiment, as illustrated in FIG. 2, the device 10 may incorporate a mounting package 28 for securing the device 10 to a floor or other base surface. In this embodiment, the second end 15 of the waveguide 12 is first secured to the mounting package 28, which may then be secured to the floor or other base surface via one or more fastening means such as lag screws, bolts, clamps, etc. Other mounting means include, but are not necessarily limited to attachment of the device 10 to an electronic component enclosure, which is, in turn, fastened to a supporting structure. It is also contemplated herein that the device 10 may be suspended from a ceiling or other elevated structure during operation.

In basic operation, the device 10 is configured to project an acoustic beam through the apertures 18 of the waveguide 12 onto a plane, such as a horizon plane, as determined by the orientation of the device 10. More particularly, the device 10 is configured to produce boundary conditions within the waveguide 12 resulting in the most efficient transfer of acoustic energy from the device 10 into the transverse plane perpendicular to the longitudinal axis of the waveguide 12.

At optimum efficiency during operation, the device 10 suitably exhibits at least two characteristics: (1) substantially similar sound pressure level (“SPL”) at each aperture 18, and (2) maximum transduction efficiency of electrical energy to acoustic energy. The result is an acoustic pressure maximum at each aperture 18 location whereby the device 10 maintains a quasi plane wavefront of constant cross-section as wave 30 propagates within the waveguide 12—resulting in a standing wave having a standing wave ratio:

SWR=A_{d}(y)/Aᵣ(y)

where A_{d}(y) is the direct transmitted wave amplitude;

Aᵣ(y) is the reflected wave amplitude; and

y is the vertical coordinate.

Since a particular device 10 may be configured as desired, the above characteristics may be achieved concurrently through the manipulation or adjustment of one or more operational parameters until optimum efficiency is realized. Key operational parameters that may be manipulated or adjusted include, but are not necessarily limited to (a) the length of the waveguide 12, (b) the configuration of the inner surface of the waveguide 12, (c) the inner width or diameter of the waveguide 12, (d) the dimensions of each of the apertures 18, (e) the distance between the reflector surface 16 and the nearest aperture set thereto, (f) the distance between the acoustic source 14 and the nearest aperture set thereto, or in the alternative, the distance between the first open end 13 and the nearest aperture set thereto, (g) the distance between adjacent aperture sets, and (h) the acoustic frequency generated by the acoustic source 14.

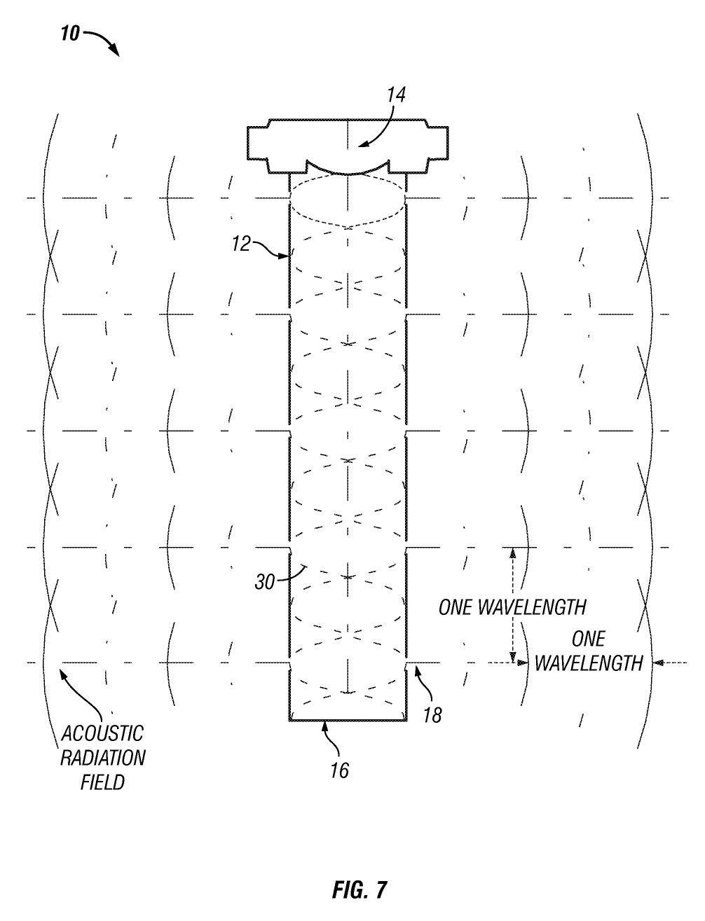

In one simplified illustration as depicted in FIG. 7, optimum efficiency of the device 10 may be realized at a given acoustic frequency of the acoustic source 14 by:

(I) providing a waveguide 12 comprising (a) a cylindrical inner wall, (b) sets of equiangular apertures 18 in the waveguide 12 wall that are (i) spaced apart at equal intervals a distance equal to about one wavelength, and (ii) alternated in the transverse plane with solid connectors 20 therebetween, and (c) a reflector surface 16 positioned near the second end 15 of the waveguide 12 about one-half wavelength from the nearest aperture set thereto;

and

(II) adjusting the distance between the face of the acoustic source 14 and the nearest aperture set thereto—thereby producing an acoustic pressure maximum at each of the apertures 18, including substantially uniform SPLs at each aperture 18 and maximum transduction efficiency of electrical energy to acoustic energy.

Once optimum efficiency of the device 10 is realized at a given acoustic frequency, the acoustic frequency may be monitored and/or adjusted thereafter to maintain optimum efficiency including maintaining a wavelength within the waveguide 12 that is about equal to the spacing of the aperture sets according to the relationship:

frequency=acoustic velocity/D

where D is the distance between sets of apertures. For instance, since acoustic velocity within the waveguide 12 is dependent, in part, upon ambient air temperature, it may be necessary to adjust the acoustic frequency generated by the acoustic source 14 in response to changes in ambient air temperature as a means of maintaining a desired wavelength within the waveguide 12. Therefore, it is desirable to monitor the acoustic field within the waveguide 12 over time in order to adjust the acoustic frequency to maintain the device 10 at optimum efficiency.

In one embodiment, the acoustic field within the waveguide 12 may be monitored by periodically measuring pressure amplitude at one or more desired null points. In another embodiment, the acoustic field within the waveguide 12 may be monitored by comparing acoustic pressure at or near first and final sets of apertures 18. In a particularly advantageous embodiment, one or more transducers may be located within the waveguide 12 whereby a microprocessor based frequency generator in communication with the one or more transducers may periodically analyze pressure or phase data from the transducers and thereafter act on the frequency controlled oscillator to adjust the frequency of the acoustic source 14 in order to maintain uniform SPLs at each aperture 18. A suitable transducer includes, for example, a sound sensor such as a microphone configured to convert the acoustic signal within the waveguide 12 into an electrical signal.

The device 10 may be monitored and adjusted manually or remotely, depending on the location and/or application of the device 10. In one embodiment, a user may manually adjust the device 10 as necessary. In an embodiment including a device 10 set in a remote location, the device 10 may be controlled via wireless means including, but not necessarily limited to cellular, radio, and satellite communication.

The invention will be better understood with reference to the following non-limiting examples, which are illustrative only and not intended to limit the present invention to a particular embodiment.

### EXAMPLE 1

In one non-limiting example, a device 10 was provided comprising a waveguide 12 constructed from schedule 80 aluminum pipe having the characteristics shown in the following table:

TABLE 1

| ITEM | FEATURE | |
|---|---|---|
| Length: | 70.2 | inches (178.3 cm) |
| Outer Diameter: | 5.0 | inches (12.7 cm) |
| Inner Diameter: | 4.5 | inches (11.43 cm) |
| Aperture Sets: | 5 | total |
| Apertures Per Set | 3 | total |
| Aperture Height: | 2 | inches (5.08 cm) |
| Aperture Angle: | 105 | degrees |
| Successive Aperture | 24 | degrees |
| Rotation | | |
| Solid Connector Height: | 2.0 | inches (5.08 cm) |
| Solid Connector Angle: | 15 | degrees |
| Adjustable Collars: | 5 | total (one per aperture set) |
| Adjustable Collar Height: | 2.2 | inches (5.59 cm) |
| Distance from second closed end 15 | 7.5 | inches (19.05 cm) |
| to nearest aperture set thereto | | |
| Distance from second closed end 15 | 22.5 | inches (57.15 cm) |
| to next successive aperture set | | |
| Distance from second closed end 15 | 37.5 | inches (95.25 cm) |
| to next successive aperture set | | |
| Distance from second closed end 15 | 52.5 | inches (133.35 cm) |
| to next successive aperture set | | |
| Distance from second closed end 15 | 67.5 | inches (171.45 cm) |
| to furthest aperture set thereto | | |
| Distance from first open end 13 | 2.75 | inches (6.99 cm) |
| to nearest aperture set thereto | | |

A midrange acoustic driver 14 was attached to the first open end 13 of the waveguide 12. Electrical input to the midrange acoustic driver 14 was provided by a frequency controlled oscillator.

The frequency controlled oscillator was turned on to power the acoustic source 14 to generate sound thereafter projected through the waveguide 12 and out of each aperture 18. In a controlled environment having an ambient temperature ranging from about 60° F. (about 17° C.) to about 70° F. (about 22° C.) during operation of the device 10, the SPL at each aperture set was measured using an SPL meter and recorded. Specifically, the SPL at each aperture set was recorded at various operating frequencies (ranging from 875 Hertz to 940 Hertz) and at various aperture 18 heights (ranging from about 0.1 inches (about 2.5 mm) to about 1.0 inches (about 25.4 mm)) to determine optimum operating efficiency of the device 10.

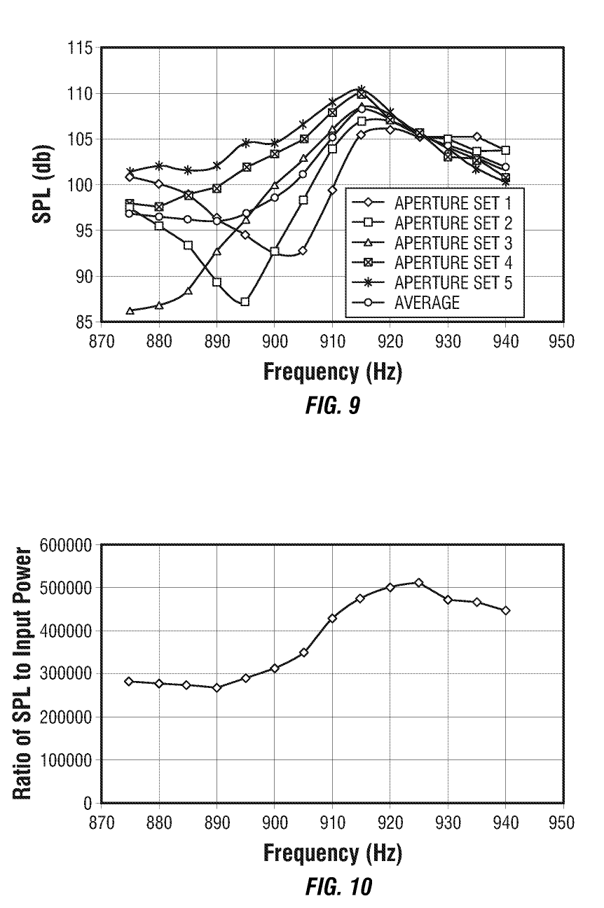

It was discovered that the device 10 achieved uniform SPLs when each collar was adjusted to provide individual aperture heights of about 0.31 inches (7.9 mm) and a distance between the upper most aperture 18 and the face of the acoustic source 14 of about 2.75 inches (6.99 cm). As FIG. 9 illustrates, the SPLs at each aperture set were measured and recorded at frequencies ranging from 875 Hertz to 940 Hertz until a crossover frequency was established, i.e., the point at which respective aperture 18 SPLs equalize. At 925 Hertz, the SPL was substantially the same at each aperture 18 (approximately 106 dB). Thus, at a frequency of 925 Hertz the SPLs at each aperture 18 cross over, i.e., measurements taken above the cross over frequency for each aperture set are in reverse order in comparison to measurements taken below the cross over frequency for each aperture set.

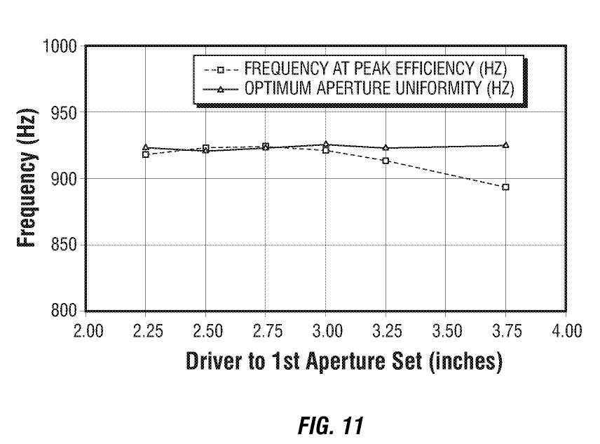

The maximum transduction efficiency of the device 10 was also established by measuring the ratio of average aperture sound pressure levels to input electrical power to the acoustic driver. As FIG. 10 illustrates, the ratio peaks at about 925 Hertz. The data of FIGS. 9 and 10 was verified by measuring the (a) frequency of peak efficiency and (b) frequency of optimum uniformity of sound pressure among aperture sets versus distance between the face of the acoustic driver and the nearest aperture set. As FIG. 11 illustrates, both maximum efficiency and aperture SPL uniformity occur at a distance between the face of the acoustic driver and the nearest aperture set of 2.75 inches.

### EXAMPLE 2

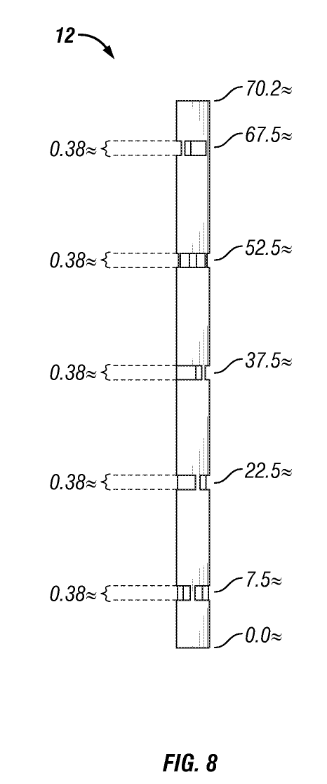

In another non-limiting example, a device 10 was provided comprising a waveguide 12 constructed from schedule 80 aluminum pipe having the characteristics as illustrated in FIG. 8 and shown in the following table:

TABLE 2

| ITEM | FEATURE | |
|---|---|---|
| Length: | 70.2 | inches (178.3 cm) |
| Outer Diameter: | 5.0 | inches (12.7 cm) |
| Inner Diameter: | 4.5 | inches (11.43 cm) |
| Aperture Sets: | 5 | total |
| Apertures Per Set | 3 | total |
| Aperture Height: | 0.38 | inches (9.7 mm) |
| Aperture Angle: | 105 | degrees |
| Successive Aperture | 24 | degrees |
| Rotation | | |
| Solid Connector Height: | 2.0 | inches (5.08 cm) |
| Solid Connector Angle: | 15 | degrees |
| Distance from second closed end 15 | 7.5 | inches (19.05 cm) |
| to nearest aperture set thereto | | |
| Distance from second closed end 15 | 22.5 | inches (57.15 cm) |
| to next successive aperture set | | |
| Distance from second closed end 15 | 37.5 | inches (95.25 cm) |
| to next successive aperture set | | |
| Distance from second closed end 15 | 52.5 | inches (133.35 cm) |
| to next successive aperture set | | |
| Distance from second closed end 15 | 67.5 | inches (171.45 cm) |
| to furthest aperture set thereto | | |
| Distance from first open end 13 | 2.75 | inches (6.99 cm) |
| to nearest aperture set thereto | | |

At an acoustic frequency of 925 Hertz, the present device 10 is configured to broadcast acoustic energy up to 360° in the transverse plane perpendicular to the longitudinal axis of the waveguide 12 to a distance of about two (2) nautical miles as required by the IALA and the U.S. Coast Guard as detailed above.

### EXAMPLE 3

In another non-limiting example, the device 10 of Example 1 is further provided, wherein microphones are placed within the waveguide 12, one microphone at each aperture set. Each microphone is connected to a microprocessor based frequency generator and configured to convert the acoustic frequency within the waveguide 12 into an electrical signal. The microprocessor based frequency generator periodically monitors the output of each microphone, analyzes pressure and/or phase data, and then makes appropriate incremental changes in frequency as generated by the midrange acoustic driver 14 attached to the first open end 13 of the waveguide 12.

Persons of ordinary skill in the art will recognize that many modifications may be made to the present application without departing from the spirit and scope of the application. The embodiment(s) described herein are meant to be illustrative only and should not be taken as limiting the invention, which is defined in the claims.

We claim:

1. An omnidirectional sound emitting device comprising:
an acoustic slotted waveguide array; and
an acoustic source in communication with the acoustic slotted waveguide array, the acoustic source configured to generate an acoustic frequency;
wherein the device is configured to project an acoustic beam at distance up to about two nautical miles or more.

2. The device of claim 1, wherein the acoustic source produces an acoustic frequency from about 400 Hertz to about 1000 Hertz.

3. The device of claim 1, wherein the acoustic frequency generated by the acoustic driver may be adjusted.

4. The device of claim 1, wherein the acoustic slotted waveguide array comprises a plurality of in-phase sets of apertures in the wall of the waveguide, the sets of apertures being equidistant from one another.

5. The device of claim 2, wherein the acoustic slotted waveguide array comprises a plurality of in-phase sets of apertures in the wall of the waveguide, the sets of apertures being equidistant from one another.

6. The device of claim 1, wherein the waveguide is constructed from a material selected from the group consisting of metals, plastics, composite materials, and combinations thereof.

7. The device of claim 1, wherein the acoustic source comprises a midrange driver unit.

8. An omnidirectional sound emitting device comprising:
a uniform cross section acoustic waveguide having a first open end and a second closed end;
an acoustic source attached to the first open end of the waveguide, said acoustic source in communication with the waveguide;
a plurality of in-phase radiating apertures in the wall of the waveguide substantially equidistant from one another.

9. The device of claim 8, wherein the acoustic waveguide is cylindrical.

10. The device of claim 8, wherein the radiating apertures comprise equiangular transverse slots through the waveguide wall.

11. The device of claim 10, wherein successive aperture sets are rotated in the transverse plane through equal angles in a manner effective whereby the device comprises no two aperture slots of the same angular orientation about the longitudinal axis of the acoustic waveguide.

12. The device of claim 11, wherein the aperture sets are rotated in the transverse plane through equal angles in a manner effective whereby the uppermost aperture set is rotated through an equal angle with respect to the bottommost aperture set.

13. The device of claim 10, wherein the slots comprise substantially similar heights.

14. The device of claim 8, further comprising solid connectors in the transverse plane of the apertures, the solid connectors configured to maintain the structural integrity of the waveguide.

15. The device of claim 8, wherein the acoustic source is an acoustic driver.

16. The device of claim 8, further comprising an attachment means for securing the device to a surface.

17. The device of claim 8, further comprising a power source providing electrical input to the acoustic source.

18. The device of claim 8, wherein the power source is a frequency controlled oscillator for directing energy to the acoustic driver.

19. The device of claim 8, further comprising a control means configured to monitor the acoustic field within the waveguide.

20. The device of claim 8, further comprising a control means configured to monitor the acoustic field within the waveguide.

21. The device of claim 20, further comprising one or more microphones located within the waveguide wall configured to convert characteristic acoustic parameters within the waveguide into an electrical signal used to monitor and control the acoustic frequency.

22. The device of claim 21, wherein said control means comprises a microprocessor based frequency generator.

23. The device of claim 22, wherein the microprocessor based frequency generator is configured to (1) monitor the output of the one or more microphones and the input impedance characteristics of the acoustic source, and (2) act on the frequency controlled oscillator to modify the frequency generated by the acoustic source to maintain pressure amplitude maxima at the apertures based on the output of the one or more microphones.

24. The device of claim 8, further comprising a waterproof outer housing enveloping the acoustic source, said housing being releasably attached to the first open end of the waveguide.

25. The device of claim 8, wherein the acoustic waveguide is constructed from aluminum.

26. An omnidirectional sound emitting device for projecting an acoustic beam onto a horizon plane comprising:
a uniform cross section acoustic waveguide;
an acoustic source in communication with the waveguide at a first end of the waveguide, wherein the acoustic source is configured to generate acoustic energy including acoustic energy propagated in a first direction along the longitudinal axis of the waveguide;
a plurality of in-phase sets of apertures in the wall of the waveguide, the sets of apertures being substantially equidistant from one another; and
a reflector surface located at a second end of the waveguide a distance from its nearest set of apertures effective to redirect the acoustic energy generated by the acoustic source in a second opposite direction through the waveguide effective to produce pressure amplitude maxima at the sets of apertures.

27. The device of claim 26, wherein the waveguide is configured to confine the acoustic energy propagated in said first direction to a wave of an essentially single dimension.

28. The device of claim 26, wherein the energy generated by the acoustic source comprises a wavelength within the waveguide equal to the distance between centers of adjacent sets of apertures.

29. The device of claim 28, wherein the wavelength within the waveguide is equal to the distance between the centers of adjacent aperture sets according to the relationship:
Frequency=Acoustic Velocity/D
where D is the distance between adjacent apertures.

30. The device of claim 28, wherein distance between the reflector surface and the aperture set furthest from the acoustic source is an integral multiple of one-half wavelength.

31. The device of claim 26, wherein successive aperture sets are rotated about the waveguide axis to avoid excessive shadowing in any direction on a plane transverse to the longitudinal axis of the waveguide.

32. The device of claim 26 further comprising a frequency controlled oscillator configured to direct the acoustic source to generate an acoustic field of a single frequency within the waveguide.

33. The device of claim 32, wherein the frequency of said oscillator is adjustable to maintain the wavelength of the acoustic wave to be equal to the distance between adjacent sets of apertures.

34. A method of projecting a constant acoustic beam onto a horizon plane, said method comprising:
providing an omnidirectional sound emitting device including,
a uniform cross section cylindrical acoustic waveguide having a first open top end and a second closed bottom end;
an acoustic source attached to the first open end of the waveguide, said acoustic source in communication with the waveguide;
a reflector surface defining the second closed end of the waveguide; and
a plurality of in-phase radiating apertures in the wall of the waveguide equidistant from one another and rotated about the waveguide axis to avoid excessive shadowing in any direction on the horizon plane;
directing the acoustic source to generate an acoustic field of a single frequency propagated in a first direction within the acoustic waveguide, the frequency having a wavelength substantially equal to the distance between adjacent radiating sources;
producing substantially similar sound pressure levels at the in phase radiating apertures to project an acoustic beam onto the horizon plane through the in phase radiating apertures;
measuring the sound pressure levels at the radiating sources; and
adjusting the frequency generated by the acoustic source to maintain similar sound pressure levels at each of the radiating in phase apertures in response to sound pressure measurements.

35. The method of claim 34 wherein the reflector surface is effective to reflect the wave generated by the acoustic source to propagate in a second opposite direction through the waveguide.

36. The method of claim 34 wherein the reflector surface is positioned near the second end of the waveguide about one-half wavelength from the nearest in phase radiating aperture thereto.

37. The method of claim 34 wherein the measuring of sound pressure level is accomplished via placing one or more microphones within the waveguide wall, wherein the one or more microphones are configured to convert the acoustic pressure within the waveguide into an electrical signal of characteristic frequency.

38. The method of claim 37 wherein adjusting of the frequency is accomplished via communicating the sound pressure characteristics measured by the one or more microphones to an audio frequency generator whereby the audio frequency generator acts on the fed back electrical signals to modify the frequency generated by the acoustic source in order to maintain pressure amplitude maxima at the radiating sources based on the output of the one or more microphones.

39. The method of claim 34 wherein the frequency generated by the acoustic source may be adjusted to produce a wavelength within the waveguide equal to the spacing between the center of the in phase radiating apertures.

40. The method of claim 34 wherein the dominant frequency of the device is inversely proportional to the internal length of the waveguide.

41. The method of claim 34 whereby the device maintains a quasi plane wavefront of constant cross-section as the wave propagates within the waveguide resulting in a standing wave having a standing wave ratio:
SWR=A_{d}(y)/Aᵣ(y)
where A_{d}(y) is the direct transmitted wave amplitude;
Aᵣ(y) is the reflected wave amplitude; and
y is the vertical coordinate.

42. The method of claim 34, wherein the omnidirectional sound emitting device may further comprise one or more adjustable collars configured to vary the dimensions of the in phase radiating apertures by covering at least part of the in phase radiating apertures by telescoping along the waveguide.

43. The method of claim 41, whereby (1) optimum sound pressure levels at each in phase radiating aperture and (2) optimum transduction efficiency of electrical energy to acoustic energy of the device may be accomplished by adjusting the distance between the acoustic source and the in phase radiating aperture nearest the acoustic source by adjusting the collar to vary the dimensions of the radiating source.

44. The method of claim 34, wherein the device projects a substantially constant acoustic beam onto a horizon plane to a distance from about one-half nautical mile to about two nautical miles.

45. The method of claim 34, wherein the device is operated in a marine environment.

46. The method of claim 45, wherein the device is mounted to a structure effective to maintain the device above sea level during operation.

47. The method of claim 34, wherein the device may be controlled remotely.

48. The method of claim 34, wherein the omnidirectional sound emitting device further includes one or more collars effective for establishing (1) the dimensions of the in phase radiating apertures and (2) the distance of the in phase radiating apertures along the waveguide relative to the first and second ends of the waveguide.

49. A method of maintaining the optimum efficiency of an acoustic slotted waveguide array as the acoustic velocity within the waveguide changes over time and temperature, the method comprising the following steps:
providing an acoustic slotted waveguide array comprising an acoustic source in communication with the waveguide at a first end, said acoustic source configured to generate an acoustic field; a reflector surface defining the second closed end of the waveguide; and a plurality of in-phase apertures in the wall of the waveguide, wherein the distance between in phase apertures is known; wherein the distance between the acoustic source and the nearest in phase aperture thereto is known; and wherein the distance between the reflector surface and the nearest in phase aperture thereto is known;
establishing an acoustic frequency effective to produce about equal sound pressure levels at all apertures;
comparing changes in the sound pressure levels at the apertures;
adjusting the acoustic frequency generated by the acoustic source as to maintain about equal sound pressure levels at all apertures during operation of the waveguide array.
